(19) United States
(12) Patent Application Publication
(10) Pub. No.: US 2024/0170797 A1
(43) Pub. Date: May 23, 2024

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(72) Inventors: Naoki FUKUSHIMA, Osaka (JP); Osamu NAKAYAMA, Osaka (JP); Katsushi MIYAZAKI, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(21) Appl. No.: 18/282,887

(22) PCT Filed: Mar. 29, 2022
(86) PCT No.: PCT/JP2022/015353

§ 371 Date: Sep. 19, 2023

(30) Foreign Application Priority Data
Apr. 9, 2021 (JP) 2021-066326

(51) Int. Cl. H01M 50/298; H01M 50/249; H01M 50/284; H01M 50/505

(52) U.S. Cl. CPC H01M 50/298; H01M 50/249; H01M 50/284; H01M 50/505; H01M 2220/20

(57) ABSTRACT

A wiring module to be attached to multiple power storage elements including electrodes includes an insulation protector made of synthetic resin having insulating properties, a busbar held by the insulation protector and connected to the electrode, a bolt including a shaft portion that extends through the busbar and a head portion that is at an end of the shaft portion, and a nut that is screwed onto the shaft portion of the bolt. The busbar includes an electrode connection portion that is connected to the electrode and extends in an extending direction and an insertion base portion that extends in a first direction crossing the extending direction and through which the shaft portion of the bolt extends. The insulation protector includes a holding portion that holds and positions the electrode connection portion and a receiving portion receiving the nut or the head portion therein.

### TECHNICAL FIELD

The present disclosure relates to a wiring module.

### BACKGROUND ART

A wiring module described in Japanese Unexamined Patent Application Publication No. 2019-192561 (Patent Document 1) is known as an example of a wiring module that is attached to power storage elements. Such a wiring module includes busbars that are connected to electrodes and an insulation protector to which the busbars are attached. Bolts and nuts are screwed to the busbars.

### PRIOR ART

Patent Document
Patent Document 1: Japanese Unexamined Patent Application Publication No. 2019-192561

### SUMMARY OF THE INVENTION

### Problem to be Solved by the Invention

If the position of the attached busbar with respect to the insulation protector is deviated from a correct position, the relative position of the bolt and the nut may be deviated from a correct position and the bolt or the nut may be contacted with the insulation protector. In screwing the bolt into the nut, a relatively large force is applied to them and a large force is also applied to the insulation protector. This may cause deformation of the insulation protector.

The technology described herein was made in view of the above circumstances. An object is to provide a wiring module that is less likely to cause deformation of an insulation protector.

### Means for Solving the Problem

A wiring module according to the present disclosure is to be attached to multiple power storage elements including electrodes. The wiring module includes an insulation protector made of synthetic resin having insulating properties, a busbar held by the insulation protector and connected to the electrode, a bolt including a shaft portion that extends through the busbar and a head portion that is at an end of the shaft portion, and a nut that is screwed onto the shaft portion of the bolt. The busbar includes an electrode connection portion that is connected to the electrode and extends in an extending direction and an insertion base portion that extends in a first direction crossing the extending direction and through which the shaft portion of the bolt extends. The insulation protector includes a holding portion that holds and positions the electrode connection portion and a receiving portion having an inner shape that is greater than an outer shape of the nut or the head portion and receiving the nut or the head portion therein. With the nut or the head portion being in the receiving portion, a first clearance defined between the receiving portion and one of the nut or the head portion with respect to the first direction is greater than a second clearance defined between the receiving portion and one of the nut or the head portion with respect to a second direction that crosses the extending direction and differs from the first direction.

### Effects of Invention

According to the present disclosure, deformation of the insulation protector is less likely to be caused.

### BRIEF DESCRIPTION OF THE DRAWINGS

FIG. 1 is a magnified cross-sectional view illustrating a portion of a power storage module according to a first embodiment and taken along I-I line in FIG. 3.

FIG. 2 is a perspective view illustrating the power storage module.

FIG. 3 is a front view illustrating the power storage module.

FIG. 4 is a perspective view illustrating a left output busbar.

FIG. 5 is a magnified cross-sectional view illustrating a fixing structure of the left output busbar.

FIG. 6 is a magnified front-view illustrating a mounting structure of the left output busbar and a connection busbar mounted on an insulation protector.

FIG. 7 is a magnified exploded view illustrating the left output busbar and the insulation protector.

FIG. 8 is a magnified plan view illustrating the power storage module.

FIG. 9 is a magnified plan view illustrating the nut that is in a receiving portion.

FIG. 10 is a magnified cross-sectional view illustrating a fixing structure of the left output busbar.

FIG. 11 is a magnified cross-sectional view illustrating a fixing structure of the left output busbar according to a comparative example.

### MODES FOR CARRYING OUT THE INVENTION

### Description of Embodiments According to the Present Disclosure

First, embodiments according to the present disclosure will be listed and described.

(1) A wiring module according to the present disclosure is to be attached to multiple power storage elements including electrodes. The wiring module includes an insulation protector made of synthetic resin having insulating properties, a busbar held by the insulation protector and connected to the electrode, a bolt including a shaft portion that extends through the busbar and a head portion that is at an end of the shaft portion, and a nut that is screwed onto the shaft portion of the bolt. The busbar includes an electrode connection portion that is connected to the electrode and extends in an extending direction and an insertion base portion that extends in a first direction crossing the extending direction and through which the shaft portion of the bolt extends. The insulation protector includes a holding portion that holds and positions the electrode connection portion and a receiving portion having an inner shape that is greater than an outer shape of the nut or the head portion and receiving the nut or the head portion therein. With the nut or the head portion being in the receiving portion, a first clearance defined between the receiving portion and one of the nut or the head portion with respect to the first direction is greater than a second clearance defined between the receiving portion and one of the nut or the head portion with respect to a second direction that crosses the extending direction and differs from the first direction.

Since the first clearance is greater than the second clearance, with the nut being screwed onto the shaft portion of the bolt, the head portion of the bolt or the nut is less likely to be contacted with the insulation protector. Accordingly, deformation of the insulation protector that may be caused by the force applied to the insulation protector by the head portion of the bolt or the nut is less likely to occur.

(2) With the shaft portion of the bolt being screwed into the nut, a direction in which an axial line of the shaft portion extends may cross the extending direction in which the electrode connection portion extends.

Even with the configuration in that the direction in which the axial line of the shaft portion of the bolt extends crosses the extending direction in which the electrode connection portion of the busbar extends, the head portion of the bolt or the nut is much less likely to be contacted with the insulation protector and the deformation of the insulation protector may not occur.

(3) The first clearance may be twice as large as the second clearance.

The head portion or the nut is much less likely to be contacted with the insulation protector and the deformation of the insulation protector is much less likely to occur.

(4) With the shaft portion of the bolt being screwed into the nut, the insertion base portion and an output terminal that is to be electrically connected to an external circuit may be held by the head portion of the bolt and the nut.

With the busbar and the output terminal being held by the head portion of the bolt and the nut, the busbar and the external circuit are electrically connected via the output terminal.

(5) A flexible board that includes a film having flexibility and conductive lines mounted on the film may be arranged on the insulation protector. The busbar may include a board connection portion that is to be connected to the conductive line of the flexible board and the board connection portion may be positioned and held by the insulation protector.

With the board connection portion being held by and positioned with respect to the insulation protector, the busbar needs to be positioned with respect to the insulation protector with higher accuracy. In such a configuration, with the nut being screwed onto the shaft portion of the bolt, the head portion of the bolt or the nut is less likely to be contacted with the insulation protector. Accordingly, the deformation of the insulation protector that is caused by the force applied to the insulation protector by the head portion of the bolt or the nut is less likely to occur.

### DETAILS OF EMBODIMENT ACCORDING TO THE PRESENT DISCLOSURE

An embodiment according to the present disclosure will be described. The present disclosure is not limited to the embodiment. All modifications within and equivalent to the technical scope of the claimed invention may be included in the technical scope of the present invention.

### First Embodiment

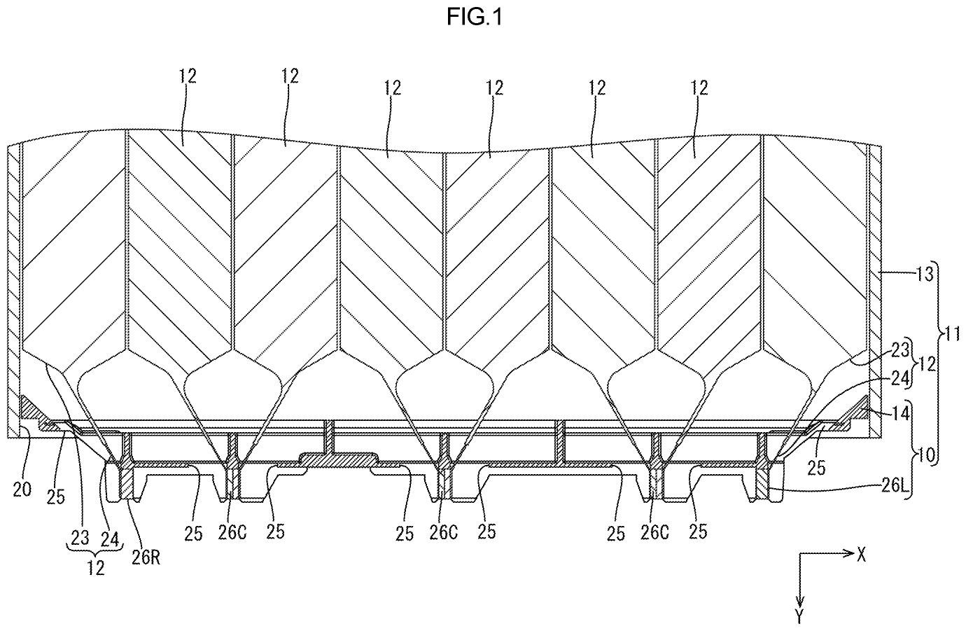

A first embodiment of the present disclosure will be described with reference to FIGS. 1 to 11. A wiring module 10 according to the first embodiment is included in a power storage module 11. The power storage module 11 is installed in a vehicle (not illustrated) as a power source for driving a vehicle such as an electric automobile or a hybrid automobile. As illustrated in FIG. 1, the power storage module 11 according to this embodiment includes a case 13, power storage elements 12 stored in the case 13, and the wiring module 10 attached to the power storage elements 12. The wiring module 10 includes connection busbars 26C, a left output busbar 26L (one example of a busbar), and a right output busbar 26R (one example of the busbar) that are connected to lead terminals 24 (one example of electrodes), and an insulation protector 14 that holds the connection busbars 26C, the left output busbar 26L, and the right output busbar 26R.

In the following description, it is considered that a Z-arrow, a Y-arrow, and an X-arrow point the upper side, the front side, and the left side, respectively. Regarding components having the same configuration, some of the components may be indicated by reference signs and others may not be indicated by the reference signs. An upper-bottom direction, a right-left direction, and a front-rear direction are perpendicular to each other.

[Whole Configuration]

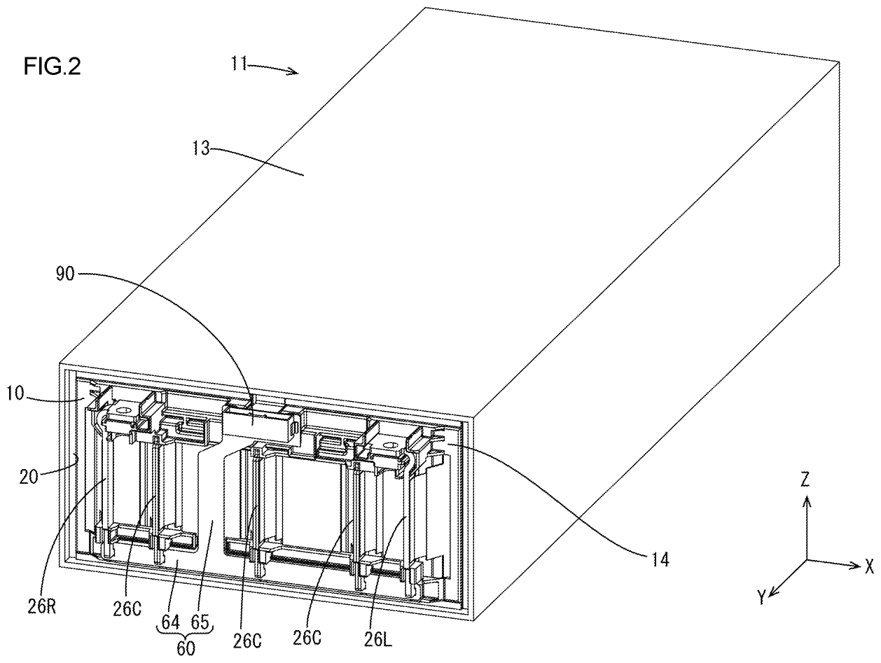

As illustrated in FIG. 2, the power storage module 11 has a rectangular parallelopiped shape elongated in the front-rear direction. As illustrated in FIG. 1, the power storage module 11 includes the power storage elements 12 that are stored in the metal case 13 with being arranged in the front-rear direction. As a whole, the case 13 has a rectangular tubular shape having openings 20 that open frontward and rearward. Any metal such as aluminum, aluminum alloy, stainless steel may be used for the metal of the case 13 as appropriate.

[Power Storage Element 12]

As illustrated in FIG. 1, the power storage element 12 includes a laminating film outer package 23 and a power generation element (not illustrated) that is inside the laminating film outer package 23. Edges of a laminating film of the laminating film outer package 23 are thermally welded. A lead terminal 24 protrudes frontward from a front edge of the laminating film outer package 23. Although details are not illustrated, a lead terminal (not illustrated) protrudes rearward from a rear edge of the laminating film outer package 23. The front lead terminal 24 and the rear lead terminal have different polarities and one of them is a positive terminal and the other one is a negative terminal.

The power storage element 12 has a plate shape extending in the front-rear direction as whole. Multiple (eight in this embodiment) power storage elements 12 are arranged in the right-left direction. The lead terminals 24 of the power storage elements 12 that are adjacent to each other in the right-left direction have different polarities.

[Insulation Protector 14]

As illustrated in FIG. 2, the insulation protector 14 is attached to a front end portion of the case 13 to close the opening 20 from the front side. The insulation protector 14 is made of insulating synthetic resin with injection molding. The insulation protector 14 has a rectangular plate shape as a whole seen in the front-rear direction. As illustrated in FIG. 1, the insulation protector 14 has slits 25 (eight slits 25 in this embodiment) that extend in the upper-bottom direction and are arranged at intervals in the right-left direction. The lead terminals 24 are inserted through the respective slits 25 from the rear side to the front side.

As illustrated in FIG. 1, the connection busbars 26C, the left output busbar 26L, and the right output busbar 26R, which are metal plates, are attached to the insulation protector 14 and are adjacent to the slits 25. The left output busbar 26L is attached to a left edge portion of the insulation protector 14. The right output busbar 26R is attached to a right edge portion of the insulation protector 14. The connection busbars 26C (three connection busbars 26C in this embodiment) are arranged between the left output busbar 26L and the right output busbar 26R.

The left output busbar 26L and the right output busbar 26R are to be electrically connected to external circuits and are used as terminal fittings for supplying power from the power storage module 11 to the external circuits.

[Left Output Busbar 26L]

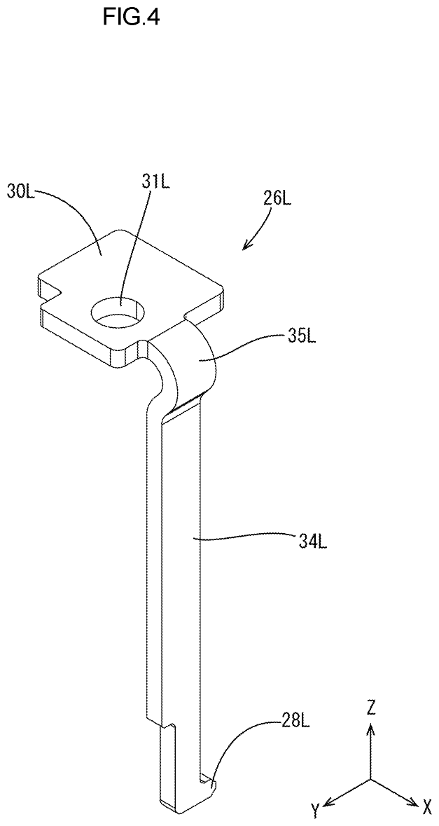

As illustrated in FIG. 4, the left output busbar 26L has a plate shape extending in the upper-bottom direction (one example of an extending direction) as a whole. The left output busbar 26L includes an electrode connection portion 34L that has a plate shape extending in the upper-bottom direction. The lead terminal 24 that is inserted through the slit 25 from the rear side is electrically connected to the electrode connection portion 34L in front of the insulation protector 14. The electrode connection portion 34L and the lead terminal 24 are connected with a known method such as welding, soldering, and brazing. In this embodiment, the electrode connection portion 34L and the lead terminal 24 are connected with laser welding.

A curved portion 35L is at an upper end of the electrode connection portion 34L. The curved portion 35L is curved rightward and has an arched shape. An insertion base portion 30L is at a right end of the curved portion 35L and extends rightward. The insertion base portion 30L and the electrode connection portion 34L are substantially perpendicular to each other. The description of being substantially perpendicular includes a configuration that the insertion base portion 30L and the electrode connection portion 34L are perpendicular to each other and also a configuration that the insertion base portion 30L and the electrode connection portion 34L are not perpendicular to each other but the relation thereof can be defined that they are substantially perpendicular to each other.

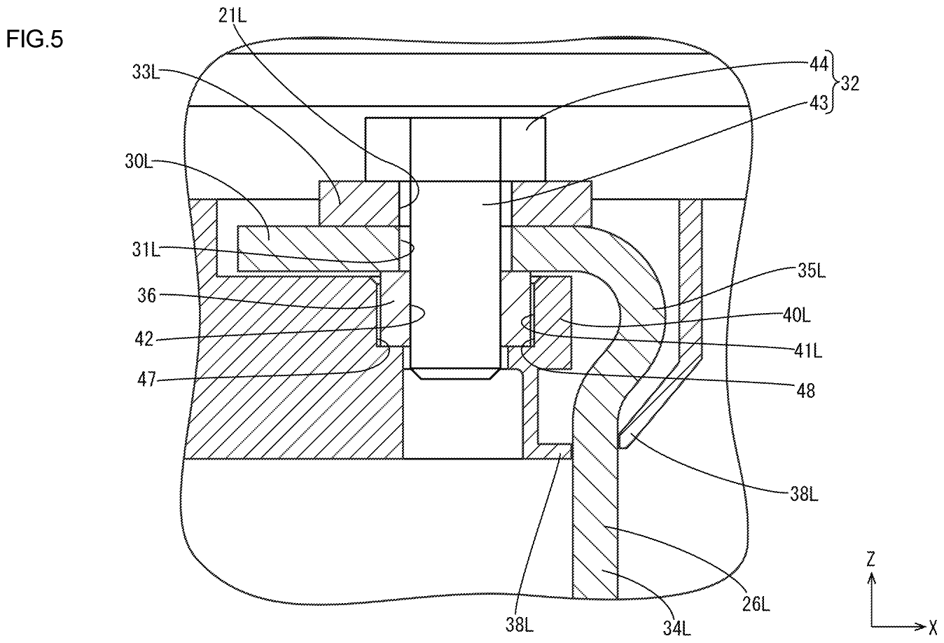

As illustrated in FIG. 5, the insertion base portion 30L is connected to an output terminal 33L that is electrically connected to an external circuit. The output terminal 33L is a metal plate. The output terminal 33L includes an insertion hole 21L that extends through the output terminal 33L in the upper-bottom direction. The insertion base portion 30L includes a through hole 31L that extends through the insertion base portion 30L in the upper-bottom direction. A bolt 32 is inserted through the through hole 31L and screwed into a nut 36 such that the left output busbar 26L is electrically connected to the output terminal 33L.

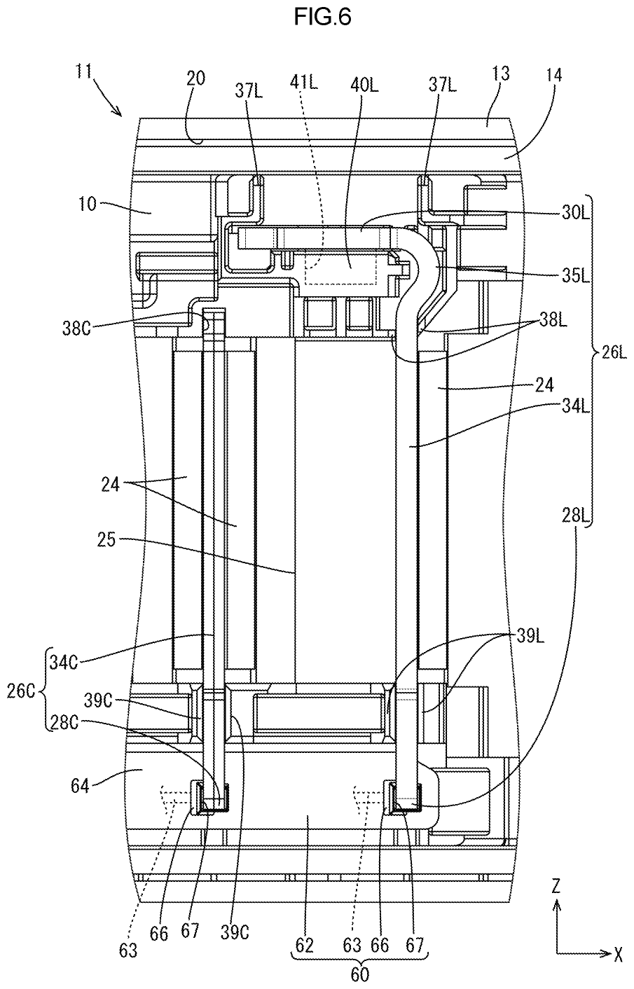

As illustrated in FIG. 6, protection walls 37L that extend in the upper-bottom direction are on the insulation protector 14 and are on right and left sides with respect to the insertion base portion 30L. Upper end portions of the protection walls 37L are bent to extend closer to each other in the right-left direction and then, extend upward. The upper end portions of the protection walls 37L form an opening that opens upward.

As illustrated in FIG. 4, a board connection portion 28L projects rearward from a lower end of the electrode connection portion 34L. The board connection portion 28L is inserted in a fixing hole 29 of the insulation protector 14 from the front side and positioned with respect to and held by the insulation protector 14.

As illustrated in FIG. 6, a pair of upper holding portions 38L that project frontward are on the insulation protector 14 and near the upper end portion of the electrode connection portion 34L. The upper holding portions 38L hold a portion of the electrode connection portion 34L that is below the curved portion 35L from two sides with respect to the right-left direction. A distance between the pair of upper holding portions 38L with respect to the right-left direction is same as or slightly smaller than a width of the electrode connection portion 34L.

As illustrated in FIG. 6, a pair of lower holding portions 39L that project frontward are on the insulation protector 14 and near the lower end portion of the electrode connection portion 34L. The lower holding portions 39L hold a portion of the electrode connection portion 34L that is above the board connection portion 28L from two sides with respect to the right-left direction. A distance between the pair of lower holding portions 39L with respect to the right-left direction is same as or slightly smaller than a width of the electrode connection portion 34L.

With the electrode connection portion 34L being held by the pair of upper holding portions 38L and the pair of lower holding portions 39L, the electrode connection portion 34L is positioned with respect to and held by the insulation protector 14.

[Right Output Busbar 26R]

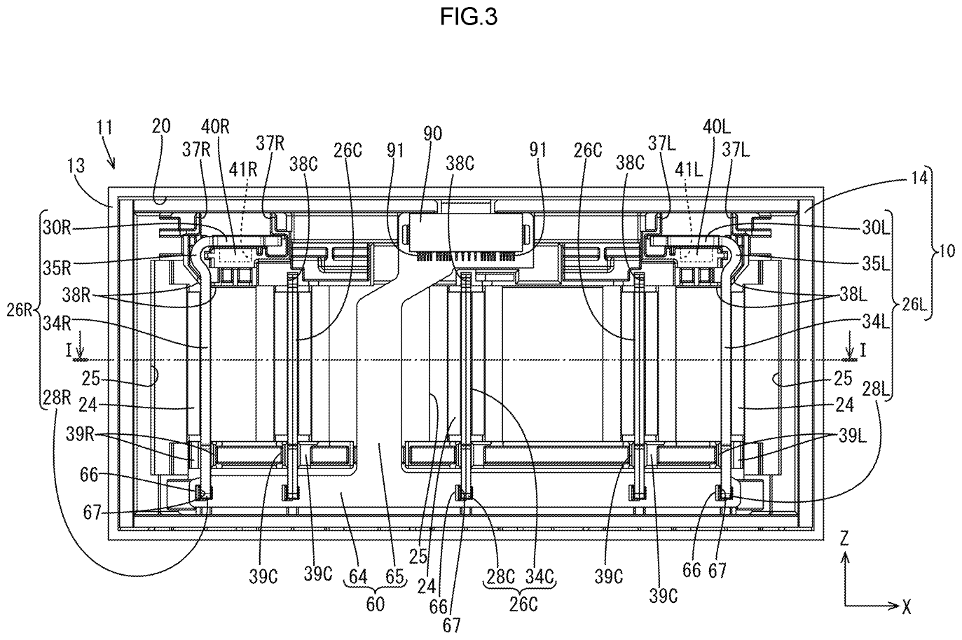

As illustrated in FIG. 3, the right output busbar 26R has a plate shape extending in the upper-bottom direction as a whole. The right output busbar 26R includes an electrode connection portion 34R that has a plate shape extending in the upper-bottom direction. As illustrated in FIG. 1, the lead terminal 24 that is inserted through the slit 25 from the rear side is electrically connected to the electrode connection portion 34R in front of the insulation protector 14. The electrode connection portion 34R and the lead terminal 24 are connected with a known method such as welding, soldering, and brazing. In this embodiment, the electrode connection portion 34R and the lead terminal 24 are connected with laser welding.

As illustrated in FIG. 3, a curved portion 35R is at an upper end of the electrode connection portion 34R. The curved portion 35R is curved leftward and has an arched shape. An insertion base portion 30R is at a left end of the curved portion 35R and extends leftward. The insertion base portion 30R and the electrode connection portion 34R are substantially perpendicular to each other. The description of being substantially perpendicular includes a configuration that the insertion base portion 30R and the electrode connection portion 34R are perpendicular to each other and also a configuration that the insertion base portion 30R and the electrode connection portion 34R are not perpendicular to each other but the relation thereof can be defined that they are substantially perpendicular to each other.

Although details are not illustrated, the insertion base portion 30R is connected to an output terminal (not illustrated) that is electrically connected to an external circuit. The output terminal is a metal plate. The output terminal includes an insertion hole (not illustrated) that extends therethrough in the upper-bottom direction. The insertion base portion 30R includes a through hole 31R that extends therethrough in the upper-bottom direction. The bolt 32 is inserted through the through hole 31R and screwed into the nut 36 such that the right output busbar 26R is electrically connected to the output terminal.

As illustrated in FIG. 3, protection walls 37R that extend in the upper-bottom direction are on the insulation protector 14 and are on right and left sides with respect to the insertion base portion 30R. Upper end portions of the protection walls 37R are bent to extend closer to each other in the right-left direction and then, extend upward. The upper end portions of the protection walls 37R form an opening that opens upward.

As illustrated in FIG. 3, a board connection portion 28R projects rearward from a lower end of the electrode connection portion 34R. The board connection portion 28R is inserted in a fixing hole (not illustrated) of the insulation protector 14 from the front side and positioned with respect to and held by the insulation protector 14.

As illustrated in FIG. 3, a pair of upper holding portions 38R that project frontward are on the insulation protector 14 and near the upper end portion of the electrode connection portion 34R. The upper holding portions 38R hold a portion of the electrode connection portion 34R that is below the curved portion 35R from two sides with respect to the right-left direction. A distance between the pair of upper holding portions 38R with respect to the right-left direction is same as or slightly smaller than a width of the electrode connection portion 34R.

As illustrated in FIG. 3, a pair of lower holding portions 39R that project frontward are on the insulation protector 14 and near the lower end portion of the electrode connection portion 34R. The lower holding portions 39R hold a portion of the electrode connection portion 34R that is above the board connection portion 28R from two sides with respect to the right-left direction. A distance between the pair of lower holding portions 39R with respect to the right-left direction is same as or slightly smaller than a width of the electrode connection portion 34R.

With the electrode connection portion 34R being held by the pair of upper holding portions 38R and the pair of lower holding portions 39R, the electrode connection portion 34R is positioned with respect to and held by the insulation protector 14.

[Connection Busbar 26C]

As illustrated in FIG. 3, the connection busbar 26C has a plate shape extending in the upper-bottom direction as a whole. The left output busbar 26L includes an electrode connection portion 34C that has a plate shape extending in the upper-bottom direction. As illustrated in FIG. 1, the lead terminal 24 that is inserted through the slit 25 from the rear side is electrically connected to the electrode connection portion 34C in front of the insulation protector 14. The electrode connection portion 34C and the lead terminal 24 are connected with a known method such as welding, soldering, and brazing. In this embodiment, the electrode connection portion 34C and the lead terminal 24 are connected with laser welding.

A board connection portion 28C projects rearward from a lower end of the electrode connection portion 34C. The board connection portion 28C is inserted in the fixing hole 29 of the insulation protector 14 from the front side and positioned with respect to and held by the insulation protector 14 (refer to FIG. 5).

As illustrated in FIG. 6, an upper holding portion 38C is in the insulation protector 14 and the upper holding portion 38C holds an upper portion of the electrode connection portion 34C from two sides with respect to the right-left direction. The upper holding portion 38C is a recess formed in a front surface of the insulation protector 14. A width of the upper holding portion 38C, which is a recess, is same as or slightly smaller than a width of the electrode connection portion 34C with respect to the right-left direction.

As illustrated in FIG. 6, a pair of lower holding portions 39C that project frontward are on the insulation protector 14 and near the lower end portion of the electrode connection portion 34C. The lower holding portions 39C hold a lower portion of the electrode connection portion 34C that is above the board connection portion 28C from two sides with respect to the right-left direction. A distance between the pair of lower holding portions 39C with respect to the right-left direction is same as or slightly smaller than a width of the electrode connection portion 34C with respect to the right-left direction.

With the electrode connection portion 34C being held by the upper holding portion 38C and the pair of lower holding portions 39C, the electrode connection portion 34L is positioned with respect to and held by the insulation protector 14.

[Flexible Printed Circuit Board 60]

As illustrated in FIG. 3, a flexible printed circuit board 60 (one example of a flexible board) is disposed on a front surface of the insulation protector 14. The flexible printed circuit board 60 includes a base film 62 (one example of a film) that is made of synthetic resin having insulating properties and conductive lines 63 that are formed on one surface or both surfaces of the base film 62. Although details are not illustrated, the base film 62 and the conductive lines 63 are covered with a coverlay film that is made of synthetic resin having insulating properties. The conductive lines 63 are made of a metal foil such as a copper foil and a copper alloy foil (refer to FIG. 5).

As illustrated in FIG. 3, the flexible printed circuit board 60 includes a lateral portion 64 that extends in the right-left direction and a vertical portion 65 that extends upward from a left side portion of the lateral portion 64 that is on a left side with respect to a middle thereof. In other words, the flexible printed circuit board 60 has a laterally reversed T-shape.

As illustrated in FIG. 3, the lateral portion 64 includes lands 66 (five lands 66 in this embodiment) at intervals with respect to the right-left direction. The lands 66 are connected to the respective conductive lines 63 (refer to FIG. 5). The coverlay film includes holes corresponding to the lands 66. Accordingly, the lands 66 are exposed to the outside.

As illustrated in FIG. 6, the lands 66 have a rectangular plan view shape seen from the front. The land 66 includes a through hole 67 that is through the land 66 and the base film 62. A hole edge of the through hole 67 is rectangular seen from the front. An inner shape of the through hole 67 is larger than outer shapes of the board connection portions 28L, 28R, 28C. Therefore, the board connection portions 28L, 28R, 28C can be inserted in the through holes 67, respectively. With the board connection portions 28L, 28R, 28C being inserted in the through holes 67, respectively, the lands 66 and the respective board connection portions 28L, 28R, 28C are soldered with a known method.

As illustrated in FIG. 3, an output connector 90 is mounted on an upper end of the vertical portion 65 of the flexible printed circuit board 60. The output connector 90 includes terminals 91. The terminals 91 are electrically connected to the conductive lines 63 with a known method such as soldering. The conductive lines 63 are electrically connected to an electronic control unit (ECU) which is an external device and not illustrated. The ECU has a known configuration including a microcomputer and components and has a function of detecting a voltage, a current, and a temperature of the power storage element 12 and has a function of controlling charging and discharging of each power storage element 12.

[Fixing Structure of Bolt 32 and Nut 36]

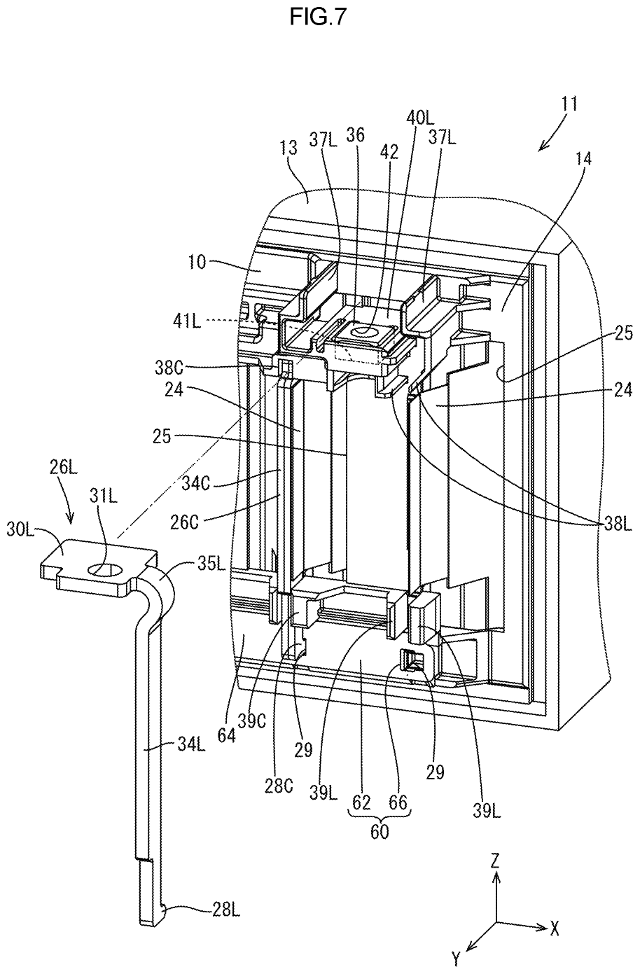

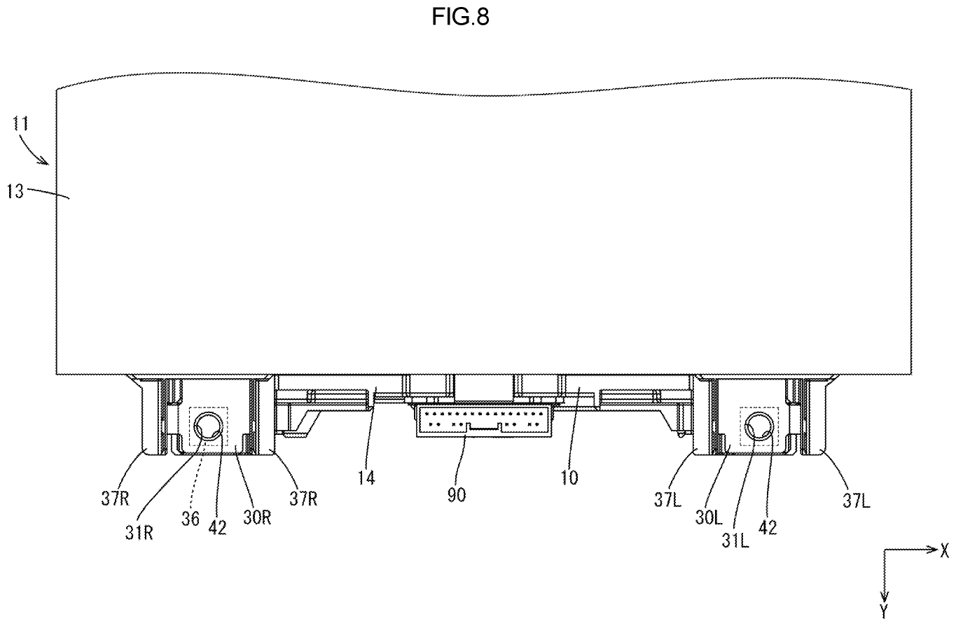

As illustrated in FIG. 5, a base seat 40L is on the insulation protector 14 and below the insertion base portion 30L. The base seat 40L has a rectangular shape seen from the above (refer to FIG. 7). As illustrated in FIG. 8, a length of the base seat 40L measured in the right-left direction is smaller than a distance between the upper ends of the two protection walls 37L. The insertion base portion 30L is disposed on the base seat 40L.

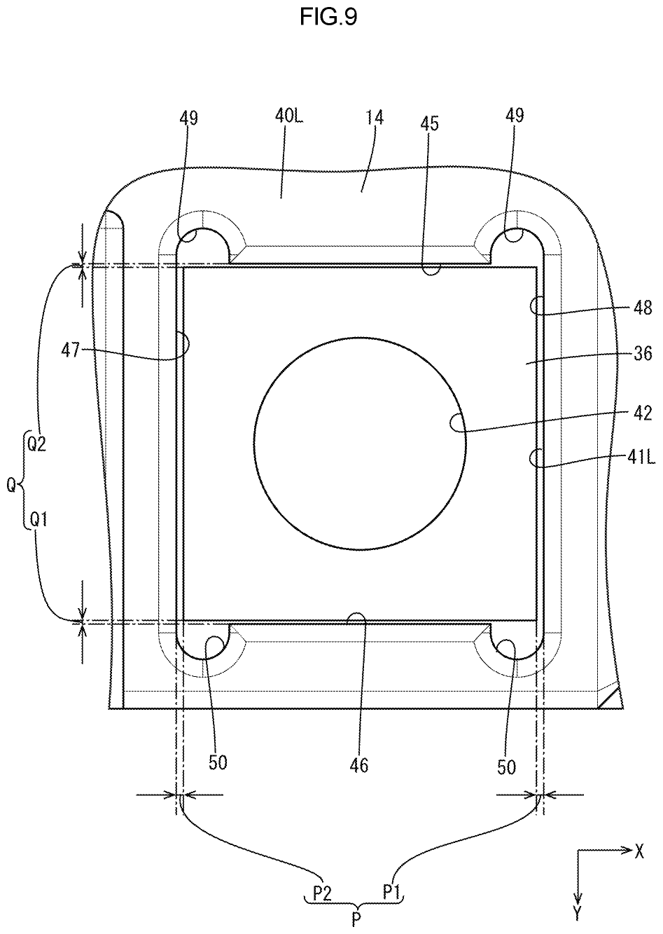

As illustrated in FIG. 9, a receiving portion 41L that receives the nut 36 therein is recessed in an upper surface of the base seat 40L. A hole edge of the receiving portion 41L is substantially rectangular seen from the above. The nut 36 made of metal is arranged in the receiving portion 41L. The nut 36 is rectangular seen from the above. The nut 36 has a screw hole 42 that extends therethrough in the upper-bottom direction. An inner diameter of the screw hole 42 is smaller than an inner diameter of the through hole 31L (refer to FIG. 5).

As illustrated in FIG. 5, with the nut 36 being arranged in the receiving portion 41L of the base seat 40L, and the insertion base portion 30L being arranged on the base seat 40L, and the output terminal 33L being disposed on the upper surface of the insertion base portion 30L, the bolt 32 is screwed into the nut 36. The bolt 32 includes a shaft portion 43 and a head portion 44. The shaft portion 43 extends in the upper-bottom direction and includes thread on an outer surface. The head portion 44 is at the upper end of the shaft portion 43.

With the shaft portion 43 of the bolt 32 being inserted through the output terminal 33L and the insertion base portion 30L, the nut 36 is screwed onto the shaft portion 43 and the output terminal 33L and the insertion base portion 30L are held by the head portion 44 of the bolt 32 and the nut 36. Accordingly, the output terminal 33L and the left output busbar 26L are electrically connected.

As illustrated in FIG. 9, the hole edge of the receiving portion 41L of the base seat 40L has a rectangular shape. The receiving portion 41L includes a rear edge portion 45, a front edge portion 46, a right edge portion 47, and a left edge portion 48. The rear edge portion 45 is a rear portion of the receiving portion 41L and extends in the right-left direction. The front edge portion 46 is a front portion of the receiving portion 41L and extends in the right-left direction. The right edge portion 47 connects a right end of the rear edge portion 45 and a right end of the front edge portion 46 and extends in the front-rear direction (one example of a second direction). The left edge portion 48 connects a left end of the rear edge portion 45 and a left end of the front edge portion 46 and extends in the front-rear direction. The rear edge portion 45 includes rear recessed portions 49 on right and left end portions thereof. The rear recessed portions 49 have a semicircular shape that is recessed rearward. The front edge portion 46 includes front recessed portions 50 on right and left end portions thereof. The front recessed portions 50 have a semicircular shape that is recessed frontward.

As illustrated in FIG. 9, with the nut 36 being arranged in the receiving portion 41L, a first clearance P is defined between an outer shape of the nut 36 and an inner shape of the receiving portion 41L with respect to the right-left direction and a second clearance Q is defined between the outer shape of the nut 36 and the inner shape of the receiving portion 41L with respect to the front-rear direction. The first clearance P is a total of a clearance P1 between a left edge of the nut 36 and the left edge portion 48 of the receiving portion 41L and a clearance P2 between a right edge of the nut 36 and the right edge portion 47 of the receiving portion 41L. The second clearance Q is a total of a clearance Q1 between a front edge of the nut 36 and the front edge portion 46 of the receiving portion 41L and a clearance Q2 between a rear edge of the nut 36 and the rear edge portion 45 of the receiving portion 41L.

The first clearance P is greater than the second clearance Q. A relative difference between the first clearance P and the second clearance Q is not particularly limited. In this embodiment, the first clearance P is substantially twice as large as the second clearance Q. The description of being substantially twice includes a configuration that the first clearance P is twice as large as the second clearance Q and also includes a configuration that the first clearance P is not twice as large as the second clearance Q but the relation thereof can be defined substantially twice. The nut 36 that is in the receiving portion 41L can be movable in the front-rear direction and the right-left direction within the range of the first clearance P and the second clearance Q between the receiving portion 41L and the nut 36.

As illustrated in FIG. 3, a base seat 40R is on the insulation protector 14 and below the insertion base portion 30R. The base seat 40R has a rectangular shape seen from the above. A length of the base seat 40R measured in the right-left direction is smaller than a distance between the upper ends of the two protection walls 37R. The insertion base portion 30R is disposed on the base seat 40R.

As illustrated in FIG. 3, a receiving portion 41R in which the nut 36 is arranged is recessed in an upper surface of the base seat 40R. A hole edge of the receiving portion 41R is substantially rectangular seen from the above. The nut 36 made of metal is arranged in the receiving portion 41R. The nut 36 is rectangular seen from the above. The nut 36 has the screw hole 42 that extends therethrough in the upper-bottom direction. An inner diameter of the screw hole 42 is smaller than an inner diameter of the insertion hole 31R.

With the nut 36 being arranged in the receiving portion 41R of the base seat 40R, and the insertion base portion 30R being arranged on the base seat 40R, and the output terminal 33R being disposed on the upper surface of the insertion base portion 30R, the bolt 32 is screwed into the nut 36. The bolt 32 includes the shaft portion 43 and the head portion 44. The shaft portion 43 extends in the upper-bottom direction and includes thread on an outer surface. The head portion 44 is at the upper end of the shaft portion 43.

Although details are not illustrated, with the shaft portion 43 of the bolt 32 being inserted through the output terminal and the insertion base portion 30R, the nut 36 is screwed onto the shaft portion and the output terminal and the insertion base portion 30R are held by the head portion 44 of the bolt 32 and the nut 36. Accordingly, the output terminal and the left output busbar 26L are electrically connected.

The first clearance P and the second clearance Q between the receiving portion 41R and the nut 36 are similar to the first clearance P and the second clearance Q between the receiving portion 41L and the nut 36 and will not be described.

### Operations and Effects of Embodiment

Next, operations and effects according to the first embodiment will be described. The operations and effects of the configuration in which the insertion base portion 30L and the electrode connection portion 34L are perpendicular to each other will be described. The electrode connection portion 34L is held and positioned by the upper holding portions 38L and the lower holding portions 39L with respect to the insulation protector 14. The lead terminal 24 of the power storage element 12 is connected to the electrode connection portion 34L. Therefore, the electrode connection portion 34L is positioned with respect to the insulation protector 14 with relatively high accuracy.

With the insertion base portion 30L and the electrode connection portion 34L being perpendicular to each other, the insertion base portion 30L is disposed parallel to the upper surface of the base seat 40L as illustrated in FIG. 5. The through hole 31L in the insertion base portion 30L is disposed to correspond to the screw hole 42 of the nut 36 that is arranged in the receiving portion 41L of the base seat 40L. The output terminal 33L is disposed on the insertion base portion 30L such that the insertion hole 21L of the output terminal 33L corresponds to the through hole 31L of the insertion base portion 30L. Then, the shaft portion 43 of the bolt 32 is inserted through the insertion hole 21L of the output terminal 33L and the insertion base portion 30L from the above and screwed into the screw hole 42 of the nut 36. This moves the nut 36 upward from the receiving portion 41L. With the bolt 32 being further screwed into the nut 36, the output terminal 33L and the insertion base portion 30L are held by the head portion 44 of the bolt 32 and the nut 36. Accordingly, the output terminal 33L, the left output busbar 26L, and the lead terminal 24 of the power storage element 12 are electrically connected.

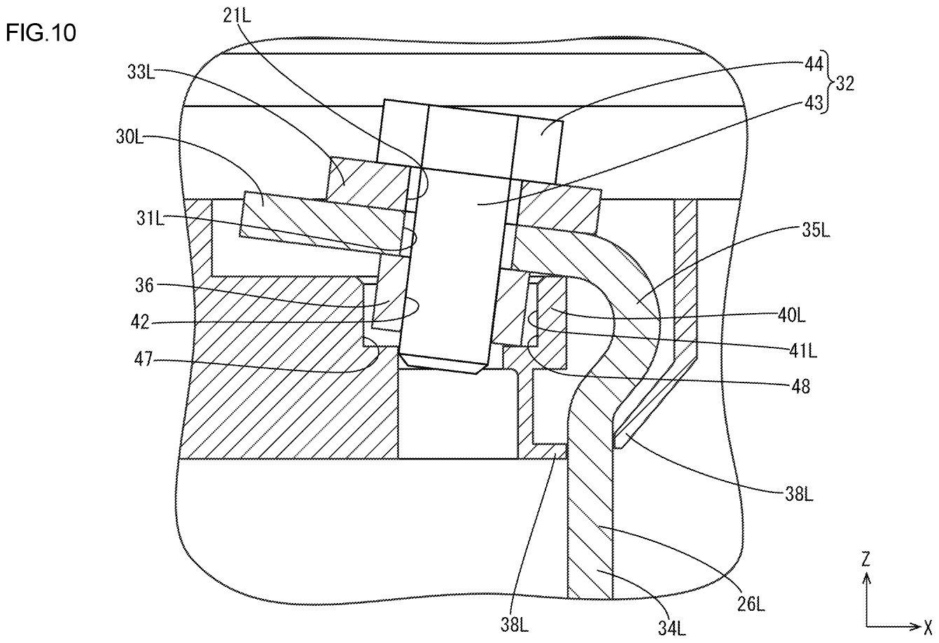

Next, as illustrated in FIG. 10, the operations and effects of the configuration in which the insertion base portion 30L and the electrode connection portion 34L are not perpendicular to each other will be described. The insertion base portion 30L and the electrode connection portion 34L are connected via the curved portion 35L. The angle formed by the insertion base portion 30L and the electrode connection portion 34L is determined by the processing accuracy with which the curved portion 35L is processed to be bent. A relatively great current flows through the left output busbar 26L from the power storage module 11. Therefore, the thickness of the left output busbar 26L is set relatively great to reduce the electric resistance value. This makes difficult to bend the curved portion 35L with a high accuracy. As a result, the angle formed by the insertion base portion 30L and the electrode connection portion 34L may not be a right angle.

FIG. 10 illustrates a configuration in which the angle formed by the insertion base portion 30L and the electrode connection portion 34L is greater than 90 degrees. In FIG. 10, the angle formed by the insertion base portion 30L and the electrode connection portion 34L is much greater than 90 degrees for easy understanding.

With the electrode connection portion 34L being held by the upper holding portions 38L and the lower holding portions 39L with respect to the insulation protector 14, the insertion base portion 30L crosses the upper surface of the base seat 40L. With such a configuration, the axial line of the screw hole 42 of the nut 36 extends in the upper-bottom direction and the axial line of the through hole 31L of the insertion base portion 30L is oblique with respect to the upper-bottom direction. With the output terminal 33L being disposed on the upper surface of the insertion base portion 30L, the axial line of the insertion hole 21L of the output terminal 33L matches the axial line of the through hole 31L of the insertion base portion 30L.

When the shaft portion 43 of the bolt 32 is inserted through the insertion hole 21L of the output terminal 33L and the through hole 31L of the insertion base portion 30L, the axial line of the shaft portion 43 of the bolt 32 matches the axial line of the insertion hole 21L of the output terminal 33L and the axial line of the through hole 31L of the insertion base portion 30L.

The nut 36 arranged in the receiving portion 41L can move in the front-rear direction and the right-left direction within the range of the first clearance P and the second clearance Q that are defined between the receiving portion 41L and the nut 36. Therefore, even if the axial line of the shaft portion 43 of the bolt 32 and the axial line of the screw hole 42 do not match, the nut 36 moves within the receiving portion 41L such that the lower end of the shaft portion 43 of the bolt 32 can be screwed into the screw hole 42 of the nut 36.

When the lower end of the shaft portion 43 of the bolt 32 is screwed into the screw hole 42 of the nut 36, the nut 36 is moved upward and the axial line of the screw hole 42 of the nut 36 matches the axial line of the shaft portion 43 of the bolt 32. Accordingly, the nut 36 is inclined with respect to the upper-bottom direction in the receiving portion 41L. The upper end of the nut 36 is disposed on the right side and the lower end is disposed on the left side with respect to the upper-bottom direction.

In this embodiment, the second clearance Q that is defined between the receiving portion 41L and the nut 36 with respect to the right-left direction is greater than the first clearance P that is defined between the receiving portion 41L and the nut 36 with respect to the right-left direction. With such a configuration, even if the nut 36 in the receiving portion 41L is inclined such that the upper end portion is disposed on the right side and the lower end is disposed on the left side, the upper end of the nut 36 is not contacted with the right edge portion 47 of the receiving portion 41L and the lower end of the nut 36 is not contacted with the left edge portion 48 of the receiving portion 41L. Accordingly, since no force is applied to the receiving portion 41L by the nut 36, deformation of the insulation protector 14 that may be caused by the force applied to the insulation protector 14 by the nut 36 is less likely to occur.

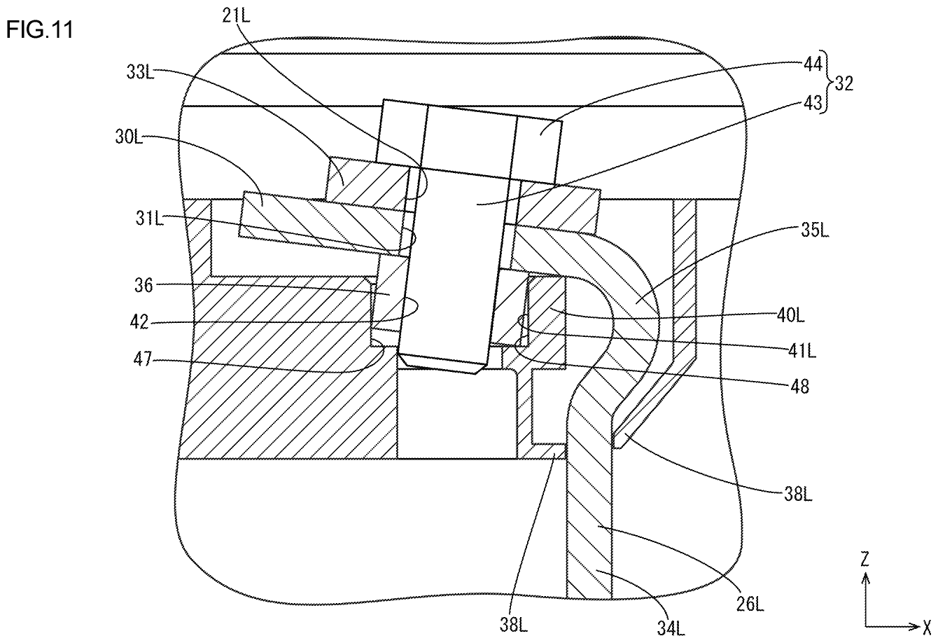

FIG. 11 illustrates a configuration of a comparative example. In the comparative example, the second clearance Q between the receiving portion 41L and the nut 36 with respect to the right-left direction is same as the first clearance P between the receiving portion 41L and the nut 36 with respect to the front-rear direction. Namely, the comparative example differs from the first embodiment in that the second clearance Q in FIG. 11 is substantially a half of the second clearance Q in FIG. 10. Other configurations are similar to those in FIG. 10 and the same components are indicated by the same reference signs as those in FIG. 10. In FIG. 11, the angle formed by the insertion base portion 30L and the electrode connection portion 34L is much greater than 90 degrees for easy understanding.

In the comparative example, if the nut 36 in the receiving portion 41L is inclined such that the upper end portion is disposed on the right side and the lower end is disposed on the left side, the upper end of the nut 36 is contacted with the right edge portion 47 of the receiving portion 41L and the lower end of the nut 36 is contacted with the left edge portion 48 of the receiving portion 41L. Then, a force is applied to the receiving portion 41L by the nut 36 and deformation of the insulation protector 14 may be caused.

In this embodiment, with the shaft portion of the bolt being screwed into the nut, the direction in which the shaft portion extends crosses the extending direction in which the electrode connection portion extends.

Even with the configuration in that the direction in which the axial line of the shaft portion 43 of the bolt 32 extends crosses the extending direction in which the electrode connection portion 34L of the left output busbar 26L or the electrode connection portion 34R of the right output busbar 26R extends, the nut 36 is less likely to be contacted with the insulation protector 14 and the deformation of the insulation protector 14 may not occur.

In this embodiment, the first clearance P is twice as large as the second clearance Q.

Accordingly, the nut 36 is much less likely to be contacted with the insulation protector 14 and the deformation of the insulation protector 14 is much less likely to occur.

According to this embodiment, with the nut 36 being screwed onto the shaft portion 43 of the bolt 32, the insertion base portion 30L and the output terminal 33L, which is to be electrically connected to an external circuit, are held by the head portion 44 of the bolt 32 and the nut 36, and the insertion base portion 30R and the output terminal, which is to be electrically connected to an external circuit, are held by the head portion 44 of the bolt 32 and the nut 36.

With the insertion base portion 30L of the left output busbar 26L and the output terminal 33L being held by the head portion 44 of the bolt 32 and the nut 36, the left output busbar 26L and the external circuit are electrically connected via the output terminal 33L. With the insertion base portion 30R of the right output busbar 26R and the output terminal 33R being held by the head portion 44 of the bolt 32 and the nut 36, the right output busbar 26R and the external circuit are electrically connected via the output terminal.

In this embodiment, the flexible printed circuit board 60, which includes the base film 62 having flexibility and the conductive lines 63 on the base film 62, is mounted on the insulation protector 14. The left output busbar 26L includes the board connection portion 28L that is connected to the conductive line 63 of the flexible printed circuit board 60. The board connection portion 28L is held by and positioned with respect to the insulation protector 14. The right output busbar 26R includes the board connection portion 28R that is connected to the conductive line 63 of the flexible printed circuit board 60. The board connection portion 28R is held by and positioned with respect to the insulation protector 14.

With the board connection portions 28L, 28R being held by and positioned with respect to the insulation protector 14, the left output busbar 26L and the right output busbar 26R need to be positioned with respect to the insulation protector 14 with higher accuracy. In such a configuration, with the nut 36 being screwed onto the shaft portion 43 of the bolt 32, the nut 36 is less likely to be contacted with the insulation protector 14. Accordingly, the deformation of the insulation protector 14 that is caused by the force applied to the insulation protector 14 by the nut 36 is less likely to occur.

### Other Embodiments

(1) The power storage elements 12 may be connected in series or connected in parallel.

(2) The head portion 44 of the bolt 32 may be arranged in the receiving portion and the nut 36 may be screwed from the above. The insulation protector 14 may include a receiving portion in which the nut 36 is arranged and another receiving portion in which the head portion 44 of the bolt 32 is arranged.

(3) The flexible board that is connected to the left output busbar 26L and the right output busbar 26R may be a so-called flexible flat cable. An electric wire may be connected to the left output busbar 26L and the right output busbar 26R.

(4) A configuration of positioning and holding the electrode connection portion 34L, 34R may not be limited to the previously described one. For instance, various methods such as bonding, fixing with screws, heat fusion, a locking structure with stopper projections, and insert molding may be used.

(5) A washer or a terminal for detecting voltage may be disposed between the head portion 44 of the bolt 32 and the nut 36 and any component may be disposed therebetween. Both or one of the left output busbar 26L and the right output busbar 26R may not be included.

(6) One connection busbar 26C, two or four or more connection busbars 26C may be mounted on the insulation protector 14.

(7) The angle formed by the insertion base portion 30L, 30R and the electrode connection portion 34L, 34R may be smaller than the right angle.

### EXPLANATION OF SYMBOLS

10: Wiring module
11: Power storage module
12: Power storage element
13: Case
14: Insulation protector
20: Opening
21L: Insertion hole
23: Laminating film outer package
24: Lead terminal
25: Slit
26C: Connection busbar
26R: Right output busbar
26L: Left output busbar
28C, 28R, 28L: Board connection portion
29: Fixing hole
30R, 30L: Insertion base portion
31R, 31L: Through hole
32: Bolt
33L: Output terminal
34C, 34R, 34L: Electrode connection portion
35: Nut
35R, 35L: Curved portion
36: Nut
37R, 37L: Protection wall
38C, 38R, 38L: Upper holding portion
39C, 39R, 39L: Lower holding portion
40R, 40L: Base seat
41R, 41L: Receiving portion
42: Screw hole
43: Shaft portion
44: Head portion
45: Rear edge portion
46: Front edge portion
47: Right edge portion
48: Left edge portion
49: Rear recessed portion
50: Front recessed portion
60: Flexible printed circuit board
62: Base film
63: Conductive line
64: Lateral portion
65: Vertical portion
66: Land
67: Through hole
90: Output connector
91: Terminal
P1, P2: Clearance
P: First clearance
Q1, Q2: Clearance
Q: Second clearance

1. A wiring module to be attached to multiple power storage elements including electrodes, the wiring module comprising:
an insulation protector made of synthetic resin having insulating properties;
a busbar held by the insulation protector and connected to the electrode;
a bolt including a shaft portion that extends through the busbar and a head portion that is at an end of the shaft portion; and
a nut that is screwed onto the shaft portion of the bolt, wherein
the busbar includes an electrode connection portion that is connected to the electrode and extends in an extending direction and an insertion base portion that extends in a first direction crossing the extending direction and through which the shaft portion of the bolt extends, and
the insulation protector includes a holding portion that holds and positions the electrode connection portion and a receiving portion having an inner shape that is greater than an outer shape of the nut or the head portion and receiving the nut or the head portion therein, and
with the nut or the head portion being in the receiving portion, a first clearance defined between the receiving portion and one of the nut or the head portion with respect to the first direction is greater than a second clearance defined between the receiving portion and one of the nut or the head portion with respect to a second direction that crosses the extending direction and differs from the first direction.

2. The wiring module according to claim 1, wherein with the shaft portion of the bolt being screwed into the nut, a direction in which an axial line of the shaft portion extends crosses the extending direction in which the electrode connection portion extends.

3. The wiring module according to claim 1, wherein the first clearance is twice as large as the second clearance.

4. The wiring module according to claim 1, wherein with the shaft portion of the bolt being screwed into the nut, the insertion base portion and an output terminal that is to be electrically connected to an external circuit are held by the head portion of the bolt and the nut.

5. The wiring module according to claim 1, wherein
a flexible board that includes a film having flexibility and conductive lines mounted on the film is arranged on the insulation protector,
the busbar includes a board connection portion that is to be connected to the conductive line of the flexible board, and
the board connection portion is positioned and held by the insulation protector.
